(19) United States
(12) Patent Application Publication
(10) Pub. No.: US 2007/0244726 A1
(43) Pub. Date: Oct. 18, 2007

(54) System and method for fully automated application and sales process

(76) Inventor: Wayne Jenkins, Wellington, FL (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/404,571

(22) Filed: Apr. 12, 2006

(51) Int. Cl. G06Q 40/00

(52) U.S. Cl. 705/4; 705/38

(57) ABSTRACT

The present invention provides a system and method for generating and processing applications for life insurance over a network, the method comprising receiving mortgage application data from a mortgage applicant, populating a life insurance application from using the mortgage application data, transmitting the life insurance application form over the network to a life insurance processing server, confirming a deposit of an initial life insurance premium with an escrow fund, inputting the mortgage application data into an electronic life insurance application form, transmitting the electronic life insurance application form over the network to an insurance provider, sending an approval confirmation of the life insurance application to the applicant if the application is accepted by the insurance provider and automatically triggering payment of the initial life insurance premium from the escrow fund.

### FIELD OF THE INVENTION

The present invention relates generally to the field of automated application and sales processing, and more particularly to the field of generating and processing applications for, and completing the sale of, insurance products.

### BACKGROUND OF THE INVENTION

Computer networks, particularly the Internet, provide increasingly important opportunities for automating the marketing and sale of various types of goods and services. Currently, the Internet extends to millions of computers in more than a hundred countries. One service that uses the Internet is the World Wide Web (the“Web”). The Web is a system of Internet servers that support documents formatted in a markup language called HyperText Markup Language “HTML”. A huge number of Web servers support HTML documents, commonly referred to as web pages, containing various types of information including text, graphics, video, and audio files. Typically, web pages are viewed on computers using web browser software, e.g., NETSCAPE NAVIGATOR or MICROSOFT'S INTERNET EXPLORER; however, web pages may also be accessed by other devices such as personal digital assistants and mobile phones.

Various technological developments have given rise to tremendous growth in the use of the Internet generally, and the Web in particular. These developments include the increased availability of both commercial and residential high-speed Internet connections, improvements in the capabilities of browser and server software, improvements in search services that allow users to quickly identify sources of useful information, and the dramatic increase in the amount of information that is available to users.

One area of particular growth has been in the use of the Internet to facilitate the application for, and sale of, mortgage products that require consumers to complete written applications containing a variety of personal and financial information. This growth has created an undeveloped opportunity for dramatically improved automation of the application and sales process in other fields.

For example, applications for various types of insurance, such as life and mortgage protection insurance, are currently processed used a mixed system that frequently takes several weeks. Typically a written application is prepared and submitted —often by mail —by the consumer, then optically scanned by the processing entity and manually checked before it can even be reviewed by an underwriter. This process is inefficient and often results in inaccurate application data, causing further delays. Moreover, it does not provide for automated processing of an initial payment in conjunction with a related event, such as mortgage funding. None of the current systems provide a fully automated solution.

In view of the above drawbacks, there exists a need for a system and method for a fully automated application and sales process.

There also exists a need for a system and method for generating and processing applications for, and completing the sale of, insurance products.

### SUMMARY OF THE INVENTION

In view of the foregoing, it is an object of the present invention to provide a system and method for a fully automated application and sales process.

It is another object of the invention to provide a system and method for generating and processing applications for, and completing the sale of, insurance products.

One aspect of the invention involves a system and method for generating and processing applications for, and completing the sale of, insurance products over a network. Specifically, the method comprises the steps of receiving application data from a third-party provider, confirming a deposit of an initial premium with an escrow fund, checking the application data and inputting the application data into an electronic application form, transmitting the electronic application form over the network to an insurance provider, sending an approval confirmation of the application to the applicant if the application is accepted by the insurance provider and automatically triggering payment of the initial premium from the escrow fund. In the preferred embodiment of the invention, the insurance provider is a life insurance provider.

In the above-identified method, the step of receiving application data from a third-party provider may involve receiving the application data by an application processing web server, which hosts a web site for processing applications. In addition, the method may further comprise the step of sending a notice of a denial of the application to the applicant if the application is denied by the insurance provider. The method may further include the step of triggering subsequent premium payments from a payment source, wherein the payment source is selected from the group consisting of: a bank account; and a credit card account. Moreover, the method may further comprise the step of directing payments to an appropriate commission recipient, wherein the commission recipient is selected from the group consisting of: an agent; a referral source; and a broker.

Another aspect of the invention involves a method for generating and processing applications for life insurance over a network, comprising receiving mortgage application data from a mortgage applicant, populating a life insurance application form using the mortgage application data, transmitting the life insurance application form over the network to a life insurance processing server, confirming a deposit of an initial life insurance premium with an escrow fund, inputting the mortgage application data into an electronic life insurance application form, transmitting the electronic life insurance application form over the network to an insurance provider, sending an approval confirmation of the life insurance application to the applicant if the application is accepted by the insurance provider and automatically triggering payment of the initial life insurance premium from the escrow fund. The method may further comprise the steps of triggering subsequent life insurance premium payments from a payment source and directing payments to an appropriate commission recipient.

### BRIEF DESCRIPTION OF THE DRAWINGS

FIG. 1 is a schematic diagram of the preferred system for generating and processing applications for, and completing the sale of, insurance products, in accordance with the principles of the invention;

FIG. 2 is a schematic diagram of preferred method for generating and processing applications for, and completing the sale of, insurance products, in accordance with the principles of the invention; and

FIG. 3 is a diagram of a preferred method for obtaining applicant information from a mortgage provider, and then transmitting the application information to the insurance application database, in accordance with the principles of the invention.

### DETAILED DESCRIPTION

In the following paragraphs, the present invention will be described in detail by way of example with reference to the attached drawings. Throughout this description, the preferred embodiment and examples shown should be considered as examples, rather than as limitations on the present invention. As used herein, the“present invention” refers to any one of the embodiments of the invention described herein, and any equivalents. Furthermore, reference to various feature(s) of the“present invention” throughout this document does not mean that all claimed embodiments or methods must include the referenced feature(s).

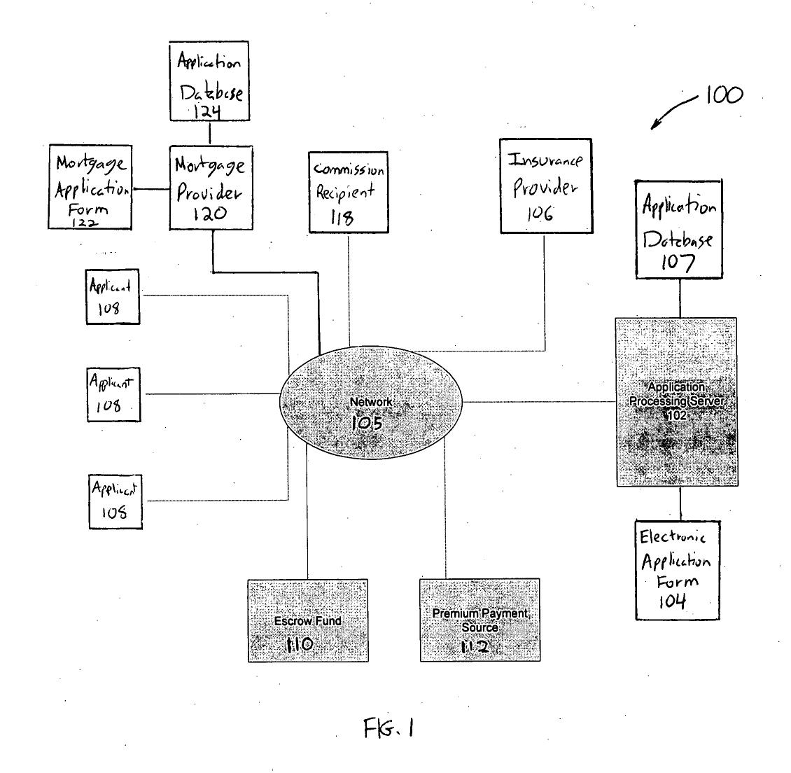

Referring to FIG. 1, a preferred application processing system 100 according to the present invention provides a highly automated application process that can be used in a variety of contexts. The system 100 includes an application processing web server 102 that generates an electronic application form 104 at the outset of the process and stores the information on an application database 107. The electronic application form 104 may be generated using electronic information regarding the applicant from another source such as a mortgage provider 120. The electronic application form 104 is transmitted over a network 105, such as the Internet, for review by a field underwriter and is electronically processed for approval by an insurance provider 106. Upon approval, documentation is automatically generated and an automated payment system is activated. An applicant 108 working from a computer may access the network 105 and submit an appropriate payment or deposit, thereby authorizing the issuance of the insurance policy.

The application processing web server 102 hosts a web site that is operated using web site processing software comprising machine-readable instructions for receiving insurance policy application data, examining the data, and automatically inputting all relevant data into the electronic insurance application form 104. The electronic insurance application form 104 is then encrypted and transmitted over the network 107 to the insurance provider 106 for processing. Since the insurance application form 104 is electronic, there is no need to scan a hard copy of the application into the system as an image file. Advantageously, when using the system 100 of the invention, the approval process takes hours rather than days or weeks. Upon approval of the application by the insurance provider 106, the application processing web server 102 sends approval confirmation to the applicant 108. In addition, the insurance provider 106 may issue the applicant 108 an insurance policy, either electronically or by mail. Status information is communicated to the web site processing software to track and follow the progress of the insurance provider 106 with respect to each application.

The initial premium payment or deposit on the policy may be put into an escrow fund 110 established for a related mortgage or home equity product. The application processing web server 102 then notifies the escrow fund 110 and triggers payment of the first premium directly from the escrow fund 110. The application processing web server 102 also triggers electronic payments for subsequent premiums from a payment source 112 such as the applicant's bank account, credit card account, or other payment source. In accordance with the invention, the application processing web server 102 also manages the payment of all commissions and fees. For example, the application processing web server 102 allocates all sales and servicing commissions, and directs payments to an appropriate commission recipient 118 such as an agent, referral source, broker, or other commission recipient.

A more detailed description of an exemplary embodiment of present invention will now be provided. This example relates to a system and method for automating an application for life insurance, but it will be understood by those of ordinary skill in the art that this method and system can be applied broadly to a variety of other insurance-related, and non-insurance related application processes, including without limitation property and casualty insurance, homeowner's insurance, health insurance, automobile insurance, and other applications.

With further reference to FIG. 1, the preferred system 100 of the invention provides a fully automated life insurance sale executed at mortgage closing using the application processing server 102 as an integrated portal from an online mortgage provider. In particular, the system 100 preferably provides insurance policies offered at true term rates, with wide flexibility, as an integrated part of the mortgage settlement process. In operation, the software residing on the application processing server 102 scours mortgage application forms 122 and/or a mortgage application database 124 for all relevant information of an applicant 108, and then automatically places the information into an electronic insurance application form 104 for the applicant 108. The software then submits the electronic application form 104 over the network 105 in encrypted form directly to the insurance provider 106. Additional functions of the software may include managing the transfer of funds for premium payment that were put into the escrow fund 110 at the time of settlement, triggering electronic payments for subsequent premiums from the payment source 112, and tracking commissions for distribution to initiating agents and agencies.

The information regarding potential applicants 108 for life insurance products may be obtained from third-party, online mortgage lending institutions or mortgage brokers. Such third-parties mortgage brokers 120 obtain applicant information from mortgage applicants through mortgage application forms 122 on their mortgage application processing web site. The mortgage application form 122 is either completed directly by the mortgage applicant or by an agent in instances where the initial contact is by telephone. After the mortgage application form 122 has been completed, the online mortgage provider 120 may transmit the mortgage application data over the network 105 to the insurance application database 107. In addition, the mortgage application data is stored by the mortgage provider 120 on the mortgage application database 124.

The mortgage application data may be transmitted using a variety of protocols that are well known to those of skill in the art. In one embodiment, the data is provided in a “web bug” or similar package that can then be viewed via the insurance application processing web site. By way of example, the web bug may open a window that displays the name, address, and social security number, date of birth, and other relevant information about the prospective applicant 108. This information preferably is automatically stored to the insurance application database 107, which may comprise a standard Oracle or MS SQL Server relational database of a type that is well known to those of skill in the art.

The application processing server 102 uses the data relating to the prospective applicant 108 to populate an appropriate electronic application form 104. Confirmation that the prospective applicant 108 wishes to submit the application to an underwriter is then obtained, either via an automated verification system such as the InstantID Q&A service provided by LEXIS/NEXIS RESEARCH SERVICE or manually by verbal communication via telephone. The electronic application form 104 is then encrypted and sent to the insurer or other underwriter.

The response to the application may be an approval, a denial, or a request for further information. The response is received by the insurance application processing server 102 and flagged for appropriate follow-up. If the response is an approval, the insurance application processing server 102 will provide automated notification to the applicant 108 or will prompt an agent to provide a verbal notification. The initial payment is then automatically debited against a credit card or other designated account and placed into an escrow fund 110 established to hold payments on the policy or multiple policies issued to the same insured. The insurance provider 106 then withdraws the first premium from the escrow fund 110 and the insurance policy is issued. The escrow fund 110 is preferably maintained with adequate funds by electronic transfer from the appropriate account designated by the insured applicant 108, such that premium payments are automatically deducted from the escrow fund 110. The insurance processing server 102 also manages the payment of all commissions and fees relating to the issuance and maintenance of the insurance policy.

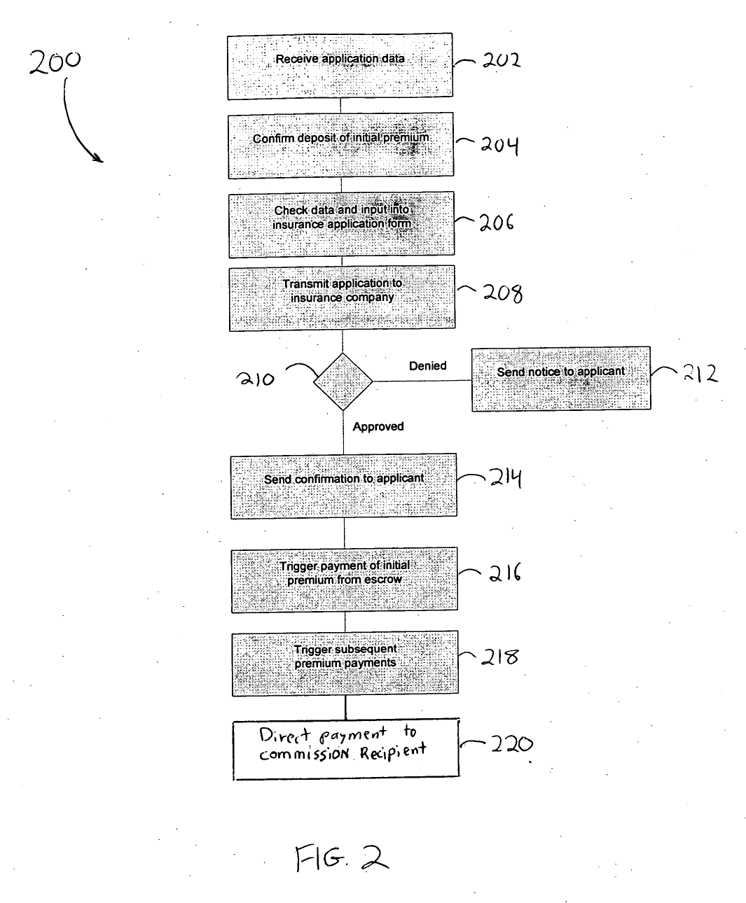

Referring to FIG. 2, a preferred method 200 for generating and processing applications for, and completing the sale of, insurance products will now be described. Advantageously, the method 200 may be completed in a matter of hours rather than weeks. In particular, the method initially entails receiving application data (step 202), for example from a mortgage provider 120. The application data is received by the application processing web server 102, which hosts a web site operated using the web site processing software of the invention. In step 204, the application processing server 102 confirms the deposit of an initial premium payment with the escrow fund 110. In subsequent step 206, the application processing server 102 checks the application data and inputs the application data into an electronic application form 104.

With further reference to FIG. 2, step 208 involves transmitting the electronic application form 104 over the network 105 to the insurance provider 106. In step 210, the insurance provider 106 makes a determination whether to approve or deny the electronic application. If the application is denied, the method proceeds to step 212, wherein a notice of the denial is sent to the applicant 108, for example via email and/or by regular mail. If the application is approved by the insurance provider 106, the method proceeds to step 214, wherein the application processing web server 102 sends an approval confirmation to the applicant 108, preferably by email. In step 216, the software residing on the application processing server 104 triggers payment of the initial premium from the escrow fund 110. An additional step may entail triggering subsequent premium payments (step 218) from the escrow fund 110 or from a payment source 112 such as the applicant's bank account, credit card account, or other payment source. A further step may include directing payments to an appropriate commission recipient 118 (step 220) such as an agent, referral source, broker, or other commission recipient.

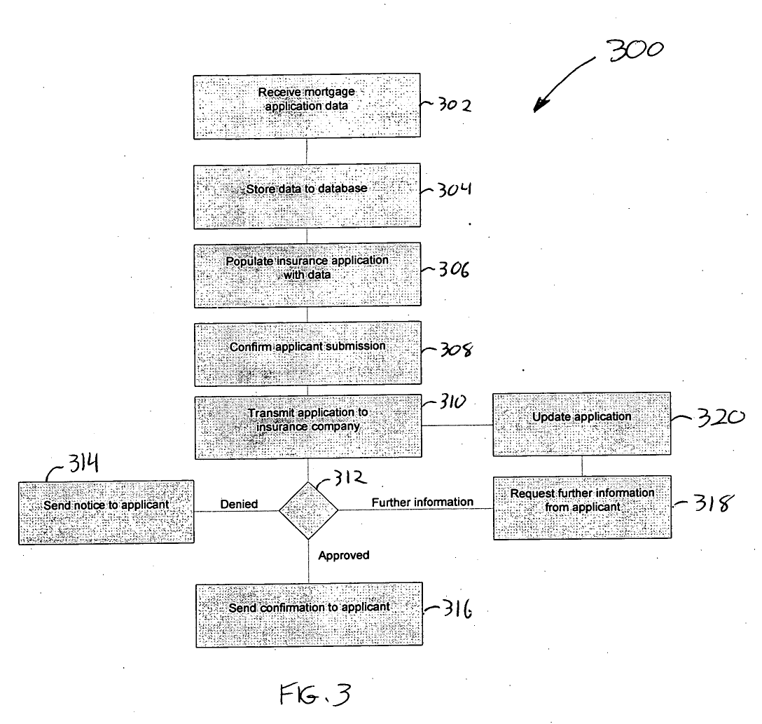

Referring to FIG. 3, a preferred method 300 for obtaining applicant information from a mortgage provider 120, and then transmitting the application information over the network 105 to the insurance application database 107, will now be described. Initially, in step 302, the mortgage provider 120 receives mortgage application data from a mortgage applicant. More particularly, a mortgage application form 122 is either completed directly by the mortgage applicant or by an agent in instances where the initial contact is by telephone. In step 304, the mortgage application data is stored on the mortgage application database 124. In subsequent step 306, an electronic insurance application form 104 is populated with the application data obtained from the mortgage applicant. Step 308 involves obtaining confirmation that the prospective applicant 108 wishes to submit the application to an underwriter, either via an automated verification system or manually by verbal communication.

With further reference to FIG. 3, step 310 involves transmitting the electronic application form 104 to the insurance provider 106 over the network 105. In step 312, the insurance provider 120 makes a decision to approve the application, deny the application or request further information. If the application is denied, the method proceeds to step 314, which involves sending a notice of denial to the applicant 108. If the application is approved, the method proceeds to step 316, which involves sending a notice of confirmation to the applicant 108. If further information is needed, the method proceeds to step 318, which involves requesting further information from the applicant 108. In step 320, applicant 108 updates the electronic application form and then re-transmits the revised application to the insurance provider in step 310.

Thus, it is seen that a system and method for generating and processing applications for, and completing the sale of, insurance products is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A method for generating and processing applications for, and completing the sale of, insurance products over a network, comprising the steps of:
receiving application data from a third-party provider;
confirming a deposit of an initial premium with an escrow fund;
checking the application data and inputting the application data into an electronic application form;
transmitting the electronic application form over the network to an insurance provider, wherein the insurance provider makes a determination whether to approve or deny the electronic application;
sending an approval confirmation of the application to the applicant if the application is accepted by the insurance provider; and
automatically triggering payment of the initial premium from the escrow fund.

2. The method of claim 1, wherein the insurance provider is a life insurance provider.

3. The method of claim 1, wherein the step of receiving application data from a third-party provider involves receiving the application data by an application processing web server, which hosts a web site for processing applications.

4. The method of claim 1, further comprising the step of sending a notice of a denial of the application to the applicant if the application is denied by the insurance provider.

5. The method of claim 1, further comprising the step of triggering subsequent premium payments from a payment source.

6. The method of claim 5, wherein the payment source is selected from the group consisting of: a bank account; and a credit card account.

7. The method of claim 1, further comprising the step of directing payments to an appropriate commission recipient.

8. The method of claim 7, wherein the commission recipient is selected from the group consisting of: an agent; a referral source; and a broker.

9. The method of claim 1, wherein the third-party provider is a mortgage provider.

10. The method of claim 9, wherein the mortgage provider receives mortgage application data from a mortgage applicant.

11. The method of claim 10, wherein the mortgage application data is stored on a mortgage application database.

12. The method of claim 10, wherein the electronic insurance application form is populated with application data obtained from the mortgage application.

13. A method for generating and processing applications for insurance products over a network, comprising the steps of:
receiving application data from a third-party provider;
inputting the application data into an electronic application form;
transmitting the electronic application form over the network to an insurance provider;
sending an approval confirmation of the application to the applicant if the application is accepted by the insurance provider; and
automatically triggering payment of an initial premium for the insurance product.

14. The method of claim 13, further comprising the step of confirming a deposit of the initial premium with an escrow fund prior to inputting the application data into the electronic application form.

15. The method of claim 13, wherein the insurance provider comprises a life insurance provider and the third-party provider comprises a mortgage provider.

16. The method of claim 13, wherein the step of receiving application data from a third-party provider involves receiving the application data by an application processing web server, which hosts a web site for processing applications.

17. The method of claim 13, further comprising the step of triggering subsequent premium payments from a payment source.

18. A method for generating and processing applications for, and completing the sale of, life insurance over a network, comprising the steps of:
receiving mortgage application data from a mortgage applicant;
populating a life insurance application form using the mortgage application data;
transmitting the life insurance application form over the network to a life insurance processing server;
confirming a deposit of an initial life insurance premium with an escrow fund;
inputting the mortgage application data into an electronic life insurance application form;
transmitting the electronic life insurance application form over the network to an insurance provider;
sending an approval confirmation of the life insurance application to the applicant if the application is accepted by the insurance provider; and
automatically triggering payment of the initial life insurance premium from the escrow fund.

19. The method of claim 18, further comprising the step of triggering subsequent life insurance premium payments from a payment source.

20. The method of claim 18, further comprising the step of directing payments to an appropriate commission recipient.
